(19) United States
(12) Patent Application Publication
(10) Pub. No.: US 2023/0331470 A1
(43) Pub. Date: Oct. 19, 2023

(54) Multi-Chamber Funnel Hopper

(71) Applicant: Hyer Industries, Inc., Pembroke, MA (US)

(72) Inventor: Frank S. HYER, Duxbury, MA (US)

(21) Appl. No.: 18/129,970

(22) Filed: Apr. 3, 2023

Related U.S. Application Data
(63) Continuation of application No. 63/330,810, filed on Apr. 14, 2022.

(51) Int. Cl. B65D 88/66; B65G 3/04

(52) U.S. Cl. CPC B65D 88/66; B65G 3/04; B65G 2201/042; B65G 2814/0319

(57) ABSTRACT

A multi-chamber funneling hopper having at least first and second frustum-shaped containers, with the second container being disposed above the first container. The first container includes a first inwardly-sloping wall and three non-inwardly-sloping walls, the walls defining a first chamber having a first inlet and a first outlet positioned below the first inlet and of smaller area than the first inlet. The second container has a second inwardly-sloping wall and three non-inwardly-sloping walls, the walls defining a second chamber having a second inlet and a second outlet of smaller area than the second inlet and as large as the first inlet of the first container. The first container and the second container define a vertical axis passing therethrough, and the first and second containers are positioned relative to each other so that the second inwardly-sloping wall is rotated in a horizontal direction approximately ninety degrees relative to the first inwardly-sloping wall.

### CROSS-REFERENCE TO RELATED APPLICATION

This application claims priority to U.S. Provisional Application No. 63/330,810 filed on 14 Apr. 2022. The entire contents of the above-mentioned application are incorporated herein by reference as if set forth herein in entirety.

### FIELD OF THE INVENTION

This invention relates to containers that hold and dispense flow-able granular solid material.

### BACKGROUND OF THE INVENTION

There are many granular solid materials that are stored in bulk and then dispensed as needed through a hopper. Granular materials include comminuted materials such as wood chips, wood shavings, and crushed stone, as well as manufactured pellets and other particulate matter. Common difficulties include compaction and “bridging” of the materials during transfer which inhibits flow through the hopper, especially wherever its cross-section narrows.

There are several devices that assist downward flow of granular materials such as agitators described in U.S. Pat. No. 2,905,365 by Thayer et al. and U.S. Pat. Nos. 3,715,059 and 4,522,500 by F. S. Hyer. Currently available vibrating panels include Thayer® Solids Flow Control BRIDGE BREAKER® flow aids from Hyer Industries in Pembroke, Massachusetts. However, each agitator device has a separate cost and consumes energy when operated.

It is therefore desirable to have a more efficient apparatus for dispensing granular materials.

### SUMMARY OF THE INVENTION

An object of the present invention is to efficiently transfer bulk granular materials from a storage unit to feeders, chutes, gates or other conventional processing devices having relatively small inlets.

Another object of the present invention is to enable controlled transfer of hard-to-discharge materials to such conventional processing devices.

Yet another object of the invention is to utilize vertical space efficiently while maintaining flow through reduced cross-sectional dimensions of an improved hopper.

This invention features a multi-chamber funneling hopper having at least first and second frustum-shaped containers, with the second container being disposed above the first container. The first container includes a first inwardly-sloping wall and three non-inwardly-sloping walls, the walls defining a first chamber having a first inlet and a first outlet positioned below the first inlet and of smaller area than the first inlet. The second container has a second inwardly-sloping wall and three non-inwardly-sloping walls, the walls defining a second chamber having a second inlet and a second outlet of smaller area than the second inlet and as large as the first inlet of the first container. The first container and the second container define a vertical axis passing therethrough, and the first and second containers are positioned relative to each other so that the second inwardly-sloping wall is rotated in a horizontal direction approximately ninety degrees relative to the first inwardly-sloping wall.

In some embodiments, the second container is attached to the first container, such as being rigidly and/or releasably attached with fasteners that join matching flanges on the containers. In one embodiment, the containers are monolithic polyhedral frustums. In certain embodiments, each of the non-inwardly-sloping walls of the first and second containers has a downward slope ranging from zero to five degrees outwardly relative to the vertical axis. In some embodiments, the vertical axis passes through all of the inlets and the outlets.

In a number of embodiments, at least one textured surface, such as an expanded metallic screen, is positioned on at least one of the first inwardly-sloping wall and the second inwardly-sloping wall, wherein the textured surface is configured to be vibrated by selective activation of a driver that is external to the first and second containers. The slope of each inwardly-sloping wall is inclined at an angle, also referred to herein as an effective angle, selected such that uncompacted granular solid material slides freely (primarily by force of gravity) along that wall when (i) no textured surface is present or (ii) the textured surface is vibrated, yet the material does not slide freely over the textured surface when not vibrated. In some embodiments, the first inwardly-sloping wall and the second inwardly-sloping wall are each inclined at an angle ranging from twenty-five degrees to fifty-five degrees inwardly relative to the vertical axis.

This invention further features a funneling hopper having at least three frustum-shaped containers, preferably four containers, in ascending order. The first, second and third containers are positioned relative to each other so that the second inwardly-sloping wall is rotated in a first horizontal direction approximately ninety degrees relative to the first inwardly-sloping wall and the third inwardly-sloping wall is rotated in the first horizontal direction approximately ninety degrees relative to the second inwardly-sloping wall. When present, the fourth inwardly-sloping wall preferably is rotated in the first horizontal direction ninety degrees relative to the third inwardly-sloping wall.

In certain embodiments, the first outlet of the first container is square and the fourth inlet of the fourth container is square. In some embodiments, the first outlet of the first container is the ultimate outlet of the hopper and the fourth inlet is the initial inlet of the hopper. In one embodiment, at least one baffle is attached to the fourth container near the fourth inlet and proximate to the vertical axis to divert incoming granular material away from directly passing through the fourth outlet. In a number of embodiments, the funneling hopper is configured such that granular material initially fed into the hopper at an off-center position will be directed to cascade off the upper-most inwardly-sloping wall directly to the next inwardly-sloping wall immediately below which establishes a spiraling action to the downward flow during filling operations.

### BRIEF DESCRIPTION OF THE DRAWINGS

In what follows, preferred embodiments of the invention are explained in more detail with reference to the drawings, in which:

FIGS. 1A-1D are schematic perspective views of a funneling hopper according to the present invention;

FIGS. 2A-2D are schematic elevational views of the hopper of FIGS. 1A-1D;

FIG. 3A is a top plan view of a template for manufacturing the hopper of FIGS. 1A-2D;

FIG. 3B is a schematic elevational view of an inwardly-sloping wall and an essentially vertical wall relative to a vertical axis;

FIG. 4 is a schematic perspective view of a funneling hopper according to the present invention having textured surfaces disposed on the inner surface of inwardly-sloping walls and flow aids disposed on outer surfaces plus a controller; and

FIGS. 5A-5C are schematic side, back and top views, respectively, of the hopper of FIG. 4, with the hopper itself considered to be transparent in FIG. 5C to show the relative positions of the flow aids.

### DETAILED DESCRIPTION OF THE PRESENTLY PREFERRED EMBODIMENTS

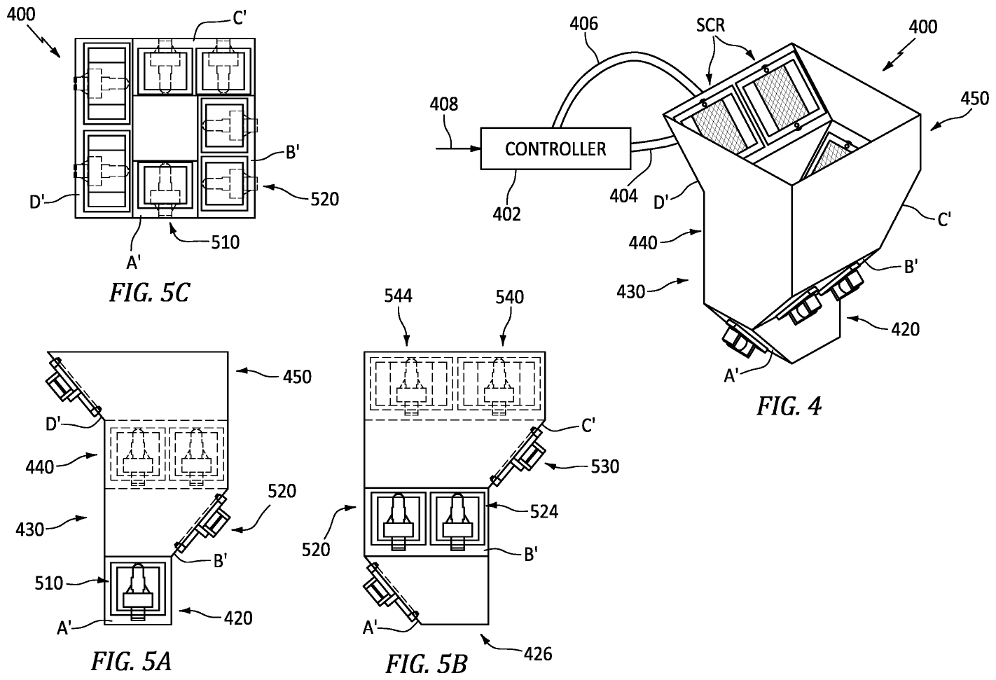

This invention may be accomplished by a multi-chamber hopper having one inwardly-sloping wall per chamber. At least a second chamber is positioned above a first chamber with the second chamber outlet rotated relative to the bottom chamber outlet. In preferred constructions, one or more textured panels are disposed on at least the lower-most inwardly-sloping wall. In some constructions, at least one of the panels is selectively vibrated by a control system such as described below in relation to FIG. 4.

The term “essentially vertical” as utilized herein for walls means a downwardly-extending wall having an angle ranging from zero to five degrees outwardly-sloping from vertical in the downward direction.

The term “approximately ninety degrees” rotation as utilized herein means a horizontal angle ranging from 87 degrees to 93 degrees to account for manufacturing tolerances in fabricating an angle of 90 degrees.

The term “textured” as utilized herein for inwardly-sloping surfaces includes non-smooth, roughened, and higher coefficient of friction surfaces than for outwardly-sloping surfaces of essentially vertical walls.

The term “effective” as utilized herein refers to the actual parameter experienced during use of a device according to the present invention, such as an “effective angle” of an inwardly-sloping wall having a textured surface, wherein the effective angle is selected such that uncompacted granular solid material slides freely along that wall when the textured surface is vibrated yet does not slide freely over the textured surface when not vibrated.

The term “portion” as utilized herein refers to a section or region of a component, without necessarily indicating any physical difference between two or more portions apart from location such as “upper portion” and “lower portion”.

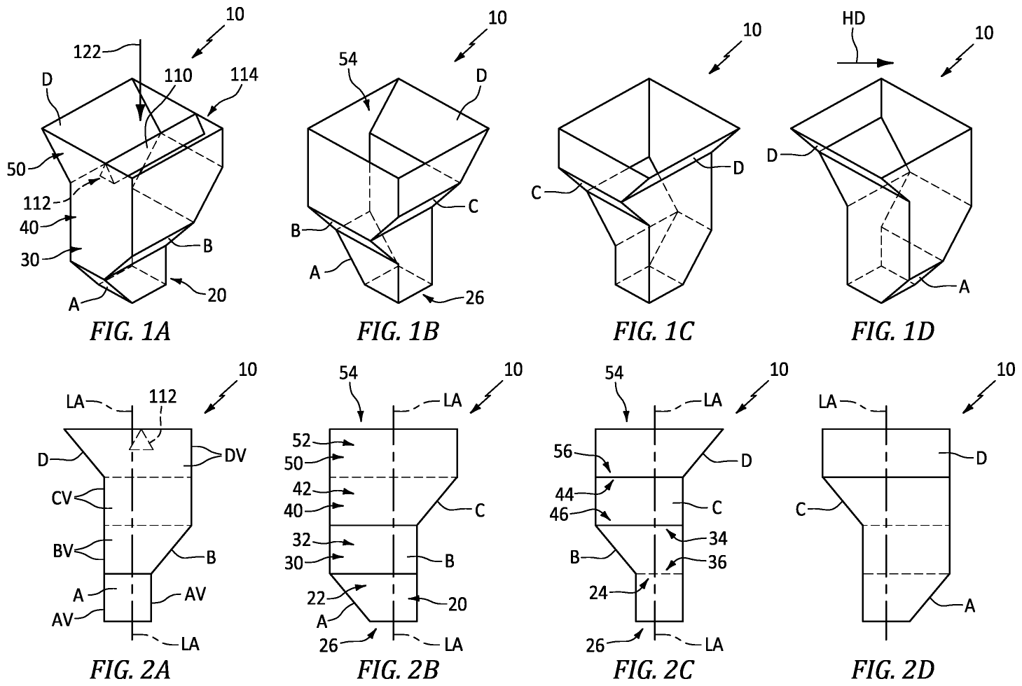

As illustrated in FIGS. 1A-2D for one construction according to the present invention, funneling hopper 10 includes a first frustum-shaped container 20 having a first inwardly-sloping wall A and three essentially vertical walls AV. The walls A and AV define a first chamber 22 having a first inlet 24 and a first outlet 26 positioned below the first inlet 24 and of smaller area than the first inlet 24.

A second frustum-shaped container 30 is disposed above the first container 20 and having a second inwardly-sloping wall B and three essentially vertical walls BV. The walls B and BV define a second chamber 32 having a second inlet 34 and a second outlet 36 of smaller area than the second inlet 34 and as large as the first inlet 24 of the first container 20.

A third frustum-shaped container 40 is disposed above the second container 30 and having a third inwardly-sloping wall C and three essentially vertical walls CV. The walls C and CV define a third chamber 42 having a third inlet 44 and a third outlet 46 of smaller area than the third inlet 44 and as large as the second inlet 34 of the second container 30.

A fourth frustum-shaped container 50 is disposed above the third container 40 and having a fourth inwardly-sloping wall D and three essentially vertical walls DV. The walls D and DV define a fourth chamber 52 having a fourth inlet 54 and a fourth outlet 56 of smaller area than the fourth inlet 54 and as large as the third inlet 44 of the third container 40.

The first container 20, the second container 30, the third container 40 and the fourth container 50, each of which may be considered as a section of the hopper 10, define a vertical axis LA passing therethrough which, in some constructions, also defines a longitudinal center-line passing vertically through the chambers 22, 32, 42 and 52 as well as through their respective inlets and outlets. In some constructions, the vertical axis passes through all of the inlets and the outlets.

Moreover, the first, second, third and fourth containers 20, 30, 40 and 50 are positioned relative to each other so that (1) the second inwardly-sloping wall is rotated in a first horizontal direction HD ninety degrees relative to the first inwardly-sloping wall, (2) the third inwardly-sloping wall is rotated in the first horizontal direction HD ninety degrees relative to the second inwardly-sloping wall, and (3) the fourth inwardly-sloping wall is rotated in the first horizontal direction HD ninety degrees relative to the third inwardly-sloping wall. As viewed from a downward direction in FIGS. 1A-2D, the rotations are in a counter-clockwise direction in this construction of a hopper 10. The rotated positions of inwardly-sloping walls A-D enhance downward flow, especially during continuous feeding of granular material into the hopper, while resisting compaction and bridging.

Preferably during operation, granular material is initially fed into the hopper at an off-center position such indicated by arrow 122 whereby the entering material cascades off the upper-most sloping wall directly to the next sloping wall immediately below which establishes a spiraling action to the downward flow during filling operations. It is less desirable to deliver materials near the central vertical axis LA because compaction of the materials may be more likely to occur.

In some constructions, at least one optional baffle 110 is attached at baffle ends 112 and 114 to opposing walls DV of the fourth container near the fourth inlet and proximate to the vertical axis to divert incoming granular material away from directly passing through the fourth outlet.

Funneling hoppers according to the present invention can be sized beginning with a desired ultimate outlet size (that is, an ultimate effective open area) or by a desired initial opening size. In other words, specifications for a funneling hopper having stacked polyhedral frustums can be developed “from the bottom up” sized first to a working inlet of a processing device being served or “from the top down” starting with dimensions of an initial inlet that satisfy the needs of intended storage volume.

If the initial inlet of an uppermost container (the top section of the hopper) is a square, then the outlet of that uppermost (top) container will be a rectangular slot of smaller open area which requires a matching inlet for the next lower container of the hopper. In some constructions, the height of each container (and, therefore, each chamber) is the same. When four chambers are defined, each with the same height and same slope of each respective inwardly-sloping wall, then constructing the initial inlet as a square will result in the ultimate outlet being a square.

In some constructions, the height of each container (that is, each section of the hopper) is determined by limiting the area reduction (inlet to outlet) of the top container. The overall height of the hopper will then be four times the selected container height. If a slot outlet is preferred instead of a square outlet, then an odd number of containers is selected, such as having a total of three containers or five containers stacked and rotated according to the present invention.

As one example, with four containers each having a height of 25 inches and an inward slope angle of 40 degrees from vertical for its inwardly-sloping wall, an initial square inlet having a width of 54 inches and a length of 54 inches defines an open receiving area of 2915 square inches for the top, fourth container. The bottom, first container then is designed to have an ultimate outlet of 12 inches×12 inches (144 square inches) which is a 20:1 reduction from the initial inlet to the ultimate outlet over a vertical height of 100 inches (4×25 inches per section).

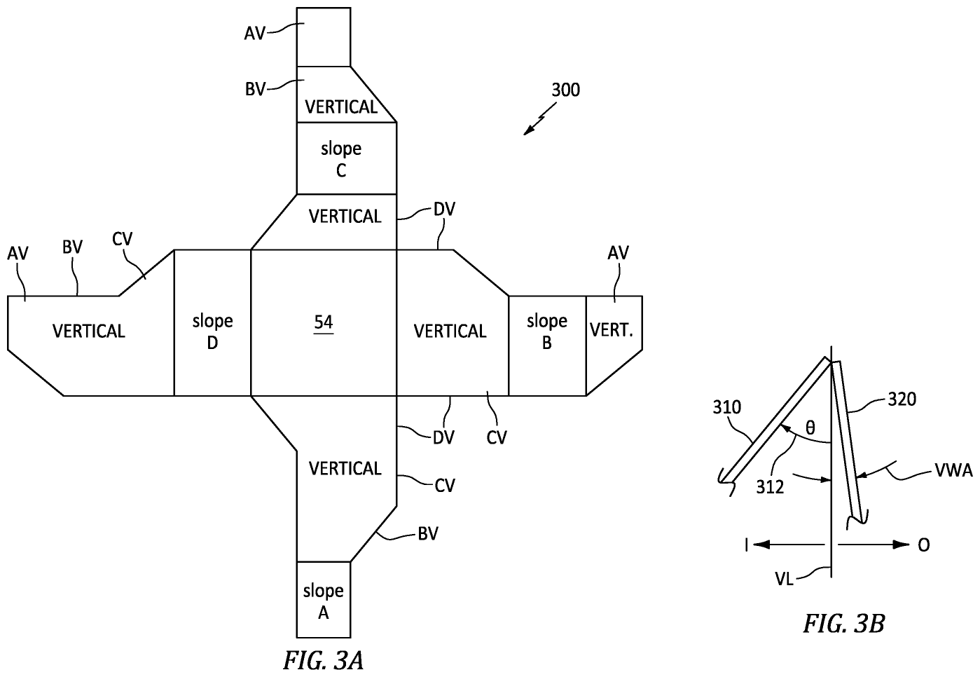

A template 300 is shown in FIG. 3A for manufacturing the hopper 10 of FIGS. 1A-2D as a single monolith of a metal alloy. Initial inlet 54 is illustrated as square opening in the center of the template 300 as defined by inwardly-sloping wall D (shown as “slope D”) and three essentially vertical walls DV (shown as “VERTICAL”) of a fourth container section 50, FIGS. 1A-2D. Some of the VERTICAL portions of template 300 include two or three sections of vertical walls AV, BV, CV and/or DV.

In alternative constructions, the at least first and second containers are polyhedral frustums that are fabricated separately and are rigidly and/or releasably attached with fasteners that join matching flanges on the containers. Rigid attachment can alternatively be provided by welds.

An inwardly-sloping wall 310 and an essentially vertical wall 320 are illustrated in FIG. 3B relative to a vertical axis VL. Inwardly-sloping wall 310 has a slope angle θ as shown by curved arrow 312 and essentially vertical wall 320 has a slope angle VWA. Wall 320 also represents non-inwardly-sloping walls. Inward direction I and outward direction θ are shown with horizontal arrows relative to vertical axis VL to represent inward sloping direction and outward sloping direction, respectively, relative to vertical axis LA of FIGS. 1A-2D, for example.

The slope of each inwardly-sloping wall is inclined at an angle θ, also referred to herein as an effective angle, selected such that uncompacted granular solid material slides freely (primarily by force of gravity) along that wall when (i) no textured surface is present or (ii) the textured surface is vibrated, yet the material does not slide freely over the textured surface when not vibrated. In some embodiments, the first inwardly-sloping wall and the second inwardly-sloping wall are each inclined at an angle θ ranging from twenty-five degrees to fifty-five degrees inwardly relative to the vertical axis. More preferably, the angle θ ranges from thirty degrees to fifty degrees, particularly between thirty-five to forty-five degrees for most materials. In certain embodiments, each of the non-inwardly-sloping walls of the first and second containers has a downward slope angle VWA ranging from zero to five degrees outwardly relative to the vertical axis.

It has been found that, while a funneling hopper according to the present invention can be utilized without any vibrating panels, many hard-to-dispense materials having interlocking tendencies, clumps and/or large particle size benefit from at least one vibrating panel on the inwardly-sloping wall of at least the bottom, first container. Suitable vibrating panels include Thayer® Solids Flow Control BRIDGE BREAKER® flow aids available from Hyer Industries in Pembroke, Massachusetts.

The present funneling hoppers provide novel geometries which (1) substantially reduce the number of flow aids normally required for conventional hoppers of equivalent storage capacity and ultimate outlet size and/or (2) maximize the effectiveness of the flow aids, especially to aid flow when vibrating and to retard flow when not vibrating, thereby providing additional techniques to limit material compaction in lower sections of the hopper.

Funneling hopper 400 according to the present invention, FIGS. 4-5C, has one or two textured surfaces disposed on an inner surface of each inwardly-sloping walls A′-D′ in this construction to illustrate maximum flow control possibilities utilizing BRIDGE BREAKER® flow aids available from Hyer Industries in Pembroke, Massachusetts. Vibratory flow aid 510 is disposed on the outer surface of wall A′ for first container 420, flow aids 520, 524 are disposed on wall B′ of second container 430, flow aids 530, 534 are disposed on wall C′ of third container 440, and flow aids 540, 544 are disposed on outer the surface of wall D′ of container 450.

A controller 402, FIG. 4, has control lines 404 and 406 which represent pneumatic or electronic control of vibrators in the flow control devices. Input arrow 408 represents optional input signals such as measured feed rate (e.g., by weight or volume) through the ultimate outlet 426. In a number of constructions, at least one textured surface, such as an expanded metallic screen SCR, FIG. 4, is positioned on at least one of the first inwardly-sloping wall and the second inwardly-sloping wall, wherein the textured surface is configured to be vibrated by selective activation of a driver that is external to the containers.

A trial utilizing mill grade wood chips of random size suggests that one or two vibrating panels are beneficial on the inwardly-sloping walls A′, B′ and C′ of first container 410, second container 420 and third container 430, respectively. Preferably, the “ON” times of panel vibrations in each container from the bottom up decreases with increasing chamber volumes.

The Thayer® BRIDGE BREAKER® Controller enables both random or synchronized actions, as well as manual override. One effective synchronized program begins by vibrating the lowest panel A′ with an “ON” time of four seconds and an “OFF” time of three seconds. The next panel B′ is instructed to be “ON” for two seconds starting at the completion of the vibratory action on panel A′. The third panel C′ then has an “ON” time of one second starting at the completion of the vibratory action on panel B′. When panel C′ completes its one-second vibration, then the cycle repeats with panel A′ vibrating.

Although specific features of the present invention are shown in some drawings and not in others, this is for convenience only, as each feature may be combined with any or all of the other features in accordance with the invention. While there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps that perform substantially the same function, in substantially the same way, to achieve the same results be within the scope of the invention. Substitutions of elements from one described embodiment to another are also fully intended and contemplated. It is also to be understood that the drawings are not necessarily drawn to scale, but that they are merely conceptual in nature.

It is the intention, therefore, to be limited only as indicated by the scope of the claims appended hereto. Other embodiments will occur to those skilled in the art after reviewing the present disclosure and are within the following claims.

What is claimed is:

1. A multi-chamber funneling hopper, comprising:
a first frustum-shaped container having a first inwardly-sloping wall and three non-inwardly-sloping walls, the walls defining a first chamber having a first inlet and a first outlet positioned below the first inlet and of smaller area than the first inlet;
a second frustum-shaped container disposed above the first container and having a second inwardly-sloping wall and three non-inwardly-sloping walls, the walls defining a second chamber having a second inlet and a second outlet of smaller area than the second inlet and as large as the first inlet of the first container;
the first container and the second container defining a vertical axis passing therethrough; and
wherein the first and second containers are positioned relative to each other so that the second inwardly-sloping wall is rotated in a horizontal direction approximately ninety degrees relative to the first inwardly-sloping wall.

2. The hopper of claim 1 wherein the second container is attached to the first container.

3. The hopper of claim 1 wherein each of the non-inwardly-sloping walls of the first and second containers has a downward slope ranging from zero to five degrees outwardly relative to the vertical axis.

4. The hopper of claim 1 wherein the vertical axis passes through all of the inlets and the outlets.

5. The hopper of claim 1 wherein at least one textured surface is positioned on at least one of the first inwardly-sloping wall and the second inwardly-sloping wall, wherein the textured surface is configured to be vibrated by selective activation of a driver that is external to the first and second containers.

6. The hopper of claim 5 wherein the slope of each inwardly-sloping wall is inclined at an angle selected such that uncompacted granular solid material slides freely along that wall when the textured surface is vibrated yet does not slide freely over the textured surface when not vibrated.

7. The hopper of claim 6 wherein the textured surface includes an expanded metallic screen.

8. The hopper of claim 1 wherein the first inwardly-sloping wall and the second inwardly-sloping wall are each inclined at an angle ranging from twenty-five degrees to fifty-five degrees inwardly relative to the vertical axis.

9. The hopper of claim 1 wherein at least the first container is formed of at least one metallic material.

10. The hopper of claim 1 wherein the first outlet of the first container is the ultimate outlet of the hopper.

11. A multi-chamber funneling hopper, comprising:
a first frustum-shaped container having a first inwardly-sloping wall and three non-inwardly-sloping walls, the walls defining a first chamber having a first inlet and a first outlet positioned below the first inlet and of smaller area than the first inlet;
a second frustum-shaped container disposed above the first container and having a second inwardly-sloping wall and three non-inwardly-sloping walls, the walls defining a second chamber having a second inlet and a second outlet of smaller area than the second inlet and as large as the first inlet of the first container;
a third frustum-shaped container disposed above the second container and having a third inwardly-sloping wall and three non-inwardly-sloping walls, the walls defining a third chamber having a third inlet and a third outlet of smaller area than the third inlet and as large as the second inlet of the second container;
the first container, the second container and the third container defining a vertical axis passing therethrough; and
wherein the first, second and third containers are positioned relative to each other so that the second inwardly-sloping wall is rotated in a first horizontal direction approximately ninety degrees relative to the first inwardly-sloping wall and the third inwardly-sloping wall is rotated in the first horizontal direction approximately ninety degrees relative to the second inwardly-sloping wall.

12. A multi-chamber funneling hopper, comprising:
a first frustum-shaped container having a first inwardly-sloping wall and three essentially vertical walls, the walls defining a first chamber having a first inlet and a first outlet positioned below the first inlet and of smaller area than the first inlet;
a second frustum-shaped container disposed above the first container and having a second inwardly-sloping wall and three essentially vertical walls, the walls defining a second chamber having a second inlet and a second outlet of smaller area than the second inlet and as large as the first inlet of the first container;
a third frustum-shaped container disposed above the second container and having a third inwardly-sloping wall and three essentially vertical walls, the walls defining a third chamber having a third inlet and a third outlet of smaller area than the third inlet and as large as the second inlet of the second container;
a fourth frustum-shaped container disposed above the third container and having a fourth inwardly-sloping wall and three essentially vertical walls, the walls defining a fourth chamber having a fourth inlet and a fourth outlet of smaller area than the fourth inlet and as large as the third inlet of the third container;
the first container, the second container, the third container and the fourth container defining a vertical axis passing therethrough; and
wherein the first, second, third and fourth containers are positioned relative to each other so that (1) the second inwardly-sloping wall is rotated in a first horizontal direction approximately ninety degrees relative to the first inwardly-sloping wall, (2) the third inwardly-sloping wall is rotated in the first horizontal direction approximately ninety degrees relative to the second inwardly-sloping wall, and (3) the fourth inwardly-sloping wall is rotated in the first horizontal direction approximately ninety degrees relative to the third inwardly-sloping wall.

13. The hopper of claim 12 wherein the vertical axis passes through all of the inlets and the outlets.

14. The hopper of claim 12 wherein the first outlet is square and the fourth inlet is square.

15. The hopper of claim 12 wherein the first outlet of the first container is the ultimate outlet of the hopper and the fourth inlet is the initial inlet of the hopper.

16. The hopper of claim 12 wherein each of the non-inwardly-sloping walls of the containers has a downward slope ranging from zero to five degrees outwardly relative to the vertical axis.

17. The hopper of claim 16 wherein the first inwardly-sloping wall and the second inwardly-sloping wall are each inclined at an angle ranging from twenty-five degrees to fifty-five degrees inwardly relative to the vertical axis.

18. The hopper of claim 12 further including at least one baffle attached to the fourth container near the fourth inlet and proximate to the vertical axis to divert incoming granular material away from directly passing through the fourth outlet.
